(19) United States
(12) Patent Application Publication
(10) Pub. No.: US 2026/0172251 A1
(43) Pub. Date: Jun. 18, 2026

(54) RATE-LIMITED TOKEN MINTING IN BLOCKCHAIN SYSTEMS

(71) Applicant: CIRCLE INTERNET GROUP, INC., New York, NY (US)

(72) Inventors: Adrian SOGHOIAN, Brooklyn, NY (US); Erik TIERNEY, Lexington, MA (US)

(21) Appl. No.: 19/536,314

(22) Filed: Feb. 11, 2026

Related U.S. Application Data
(62) Division of application No. 18/823,409, filed on Sep. 3, 2024.

(51) Int. Cl. H04L 9/32; H04L 9/00

(52) U.S. Cl. CPC H04L 9/3213; H04L 9/3297; H04L 9/50

(57) ABSTRACT

Certain aspects of the present disclosure provide techniques for minting tokens on a blockchain. An example method generally includes receiving, at a token minter from a requesting party, a request to mint a quantity of tokens on a blockchain. Based at least on an identity of the requesting party and a time-based limit associated with the token minter, a determination that the requested quantity of tokens are mintable by the token minter is made. Based on the determination that the requested quantity of tokens are mintable by the token minter, a smart contract is executed to mint at least some tokens from the requested quantity of tokens on the blockchain.

### CROSS-REFERENCE TO RELATED APPLICATIONS

This application is a divisional of U.S. patent application Ser. No. 18/823,409, filed Sep. 3, 2024, which is herein incorporated by reference

### INTRODUCTION

Aspects of the present disclosure relate to security in blockchain systems, and more specifically to securely minting tokens in blockchain systems.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

Blockchains generally allow for transactions to be performed using a variety of tokens which can be minted in various manners. For some tokens, such as stablecoins or other tokens which have value derived from some other asset (e.g., fiat currency, real-world assets, etc. for asset-backed stablecoins, other digital tokens for algorithmic stablecoins, etc.), tokens may be minted when the other assets backing these tokens are deposited, created, or otherwise made available to back the value of these tokens. In another example, for tokens which exist independently of other assets, tokens may be minted in various manners, such as upon verifying transactions on the blockchain, on an arbitrary schedule, or the like. Regardless of how tokens are minted, token minting may be a process which may be exploited. For example, if a malicious user obtains access rights to a token minter, the malicious user can generate tokens outside of the regular course by which these tokens are generated. Thus, a malicious user can generate an unlimited amount of tokens which can diminish the value of the token and thus diminish the security of a blockchain system in which tokens are used.

Accordingly, techniques are needed to control the minting of tokens in blockchain systems.

### BRIEF SUMMARY

Certain aspects provide a computer-implemented method for minting tokens on a blockchain. An example method generally includes receiving, at a token minter from a requesting party, a request to mint a quantity of tokens on a blockchain. Based at least on an identity of the requesting party and a time-based limit associated with the token minter, a determination that the requested quantity of tokens are mintable by the token minter is made. Based on the determination that the requested quantity of tokens are mintable by the token minter, a smart contract is executed to mint at least some tokens from the requested quantity of tokens on the blockchain.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example computing environment in which tokens are minted in a rate-controlled manner on a blockchain, according to aspects of the present disclosure.

FIG. 2 is a flow chart illustrating rate-controlled minting of tokens on a blockchain, according to aspects of the present disclosure.

FIG. 3 illustrates example operations for rate-controlled minting of tokens on a blockchain, according to aspects of the present disclosure.

FIG. 4 illustrates an example system on which aspects of the present disclosure can be performed.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Transactions in cryptocurrency systems may be represented as blocks in a blockchain that track a universe of transactions performed using the cryptocurrency system. These transactions may be performed using a variety of tokens; a first party to a transaction may send a quantity of tokens to second party to the transaction, and in exchange, the second party to the transaction may send a digital and/or physical asset to the first party of the transaction. In these cryptocurrency systems, processed transactions may not be modified at a later date, thus providing an immutable ledger of the transactions performed using the cryptocurrency system.

Generally, tokens used in performing transactions on a blockchain need to exist on the blockchain before such transactions are performed. To generate tokens on the blockchain, a process also known as minting, a minting authority or other minting mechanism may be used to generate new tokens and distribute these tokens to one or more wallets on the blockchain based on a variety of triggering conditions. For example, for tokens backed by real-world assets, such tokens may be generated when a real-world asset is received by the minting authority. Tokens may not be generated until corresponding real-world assets are received by the minting authority, as doing so may diminish the value of the tokens due to an imbalance between extant tokens on the blockchain and the real-world assets backing the tokens on the blockchain. For other types of tokens, such tokens may be generated when a triggering event occurs; for example, tokens may be minted and rewarded to a user on the blockchain when the user performs a specified action, such as the verification of other transactions on the blockchain.

To manage the minting of tokens on a blockchain, a token minter may be configured with a minting allowance. This minting allowance generally dictates the amount of tokens that the minter can mint and decrements over time as tokens are minted. Generally, to allow for tokens to be minted rapidly, a minter may be configured with a large minting allowance that allows for the token minting allowance to be monitored and manually reset when the token minting allowance reaches a minimum value. Because the minting allowance with which a token minter is configured allows for a large amount of tokens to be minted, compromising the token minter may introduce security vulnerabilities in the blockchain. For example, if the token minter is compromised by a malicious party, the malicious party could mint tokens on the blockchain independently of the receipt of real-world assets to back the minted tokens or independently of the occurrence of some other triggering event that would typically cause these tokens to be issued to one or more users with wallets on the blockchain. Thus, a malicious party could dilute the value of tokens in the blockchain by compromising a token minter, which may reduce trust in the token itself and token issuers on the blockchain.

Aspects of the present disclosure provide techniques for improving the security of token minting on the blockchain by using a rate-limited token minter to mint tokens on the blockchain. Generally, the rate-limited token minter can be configured with a limit replenishment rate and a maximum token minting allowance which may be significantly smaller than the minting allowance associated with a token minter that directly mints tokens on the blockchain. If the rate-limited token minter has a sufficient allowance to mint a requested amount of tokens, the rate-limited token minter can instruct the token minter to mint the requested amount of tokens. If, however, the rate-limited token minter does not have a sufficient allowance for minting the requested amount of tokens, the rate-limited token minter can attempt to use a reserve token minting allowance, and if no reserve or an insufficient reserve is available, the token minting request may be rejected. By minting tokens through a rate-limited token minter, aspects of the present disclosure may improve the security of blockchain systems by preventing malicious users from compromising the security of a token on the blockchain. For example, if a rate-limited token minter is compromised, a limited amount of tokens may be maliciously minted. By minimizing, or at least reducing, the amount of tokens that can be maliciously minted when a rate-limited token perimeter is compromised, aspects of the present disclosure may limit the effect of a compromised token minter on the value of a token on the blockchain.

### Example Rate-Limited Minting of Tokens on a Blockchain

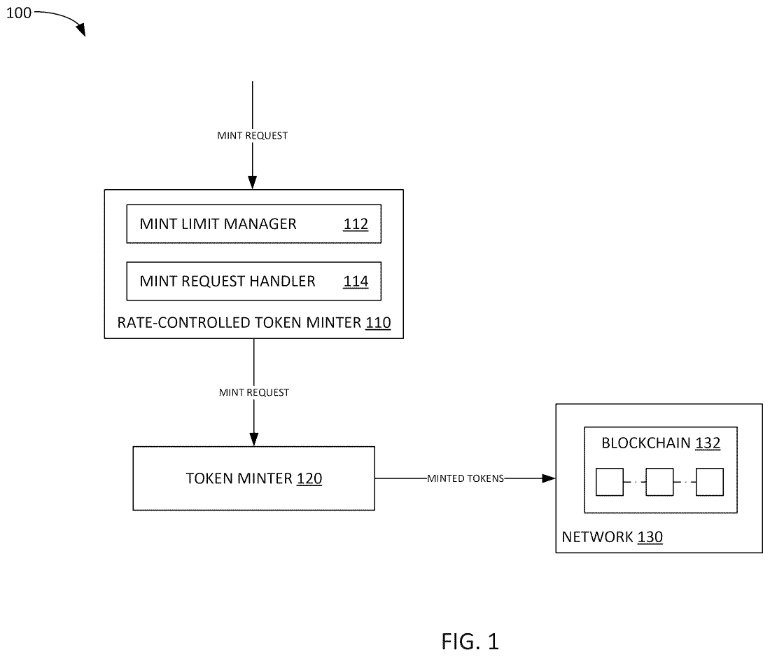

FIG. 1 illustrates an example computing environment 100 in which tokens are minted on a blockchain using a rate-limited minter, according to aspects of the present disclosure. As illustrated, computing environment 100 includes a rate-limited token minter 110, a token minter 120, and a network 130.

As illustrated, the rate-limited token minter 110 serves as an entry point for processing requests to mint tokens on the blockchain 132. While the computing environment 100 illustrates a single rate-limited token minter 110 that processes token minting requests, it should be understood that any number of rate-limited token minters 110 may be deployed within the computing environment. For example, rate-limited token minters 110 may be established to process token minting requests in different geographic regions, for different types of users, or the like. As illustrated, the rate-limited token minter 110 includes a mint limit manager 112 and a mint request handler 114.

The mint limit manager 112 generally allows for the token minting allowance for the rate-limited token minter 110 to be maintained. To maintain the token minting allowance for the rate-limited token minter 110, the mint limit manager 112 may be configured with a maximum token minting allowance and a limit replenishment rate that allows the token minting allowance to be refilled over time so that the token minting allowance for the rate-limited token minter 110 need not be manually reset when the token minting allowance is exhausted through the minting of tokens on the blockchain 132. In some aspects, the token minting allowance may include an absolute minting allowance that is replenished based on the limit replenishment rate and a time-window-based minting allowance that limits the amount of tokens that can be minted through the rate-limited token minter 110 over any period of time.

In some aspects, the mint limit manager 112 can configured the maximum token minting allowance and the limit replenishment rate based on historical token minting activity on the blockchain 132. For example, the maximum token minting allowance may be set based on historical cumulative minting activity over a time window for a given set of mint transactions (e.g., mint transactions performed by a particular set of users, mint transactions performed within a particular geographic region, etc.). The limit replenishment rate, meanwhile, may be configured based on a historical average token minting rate. In some aspects, different limit replenishment rates may be configured for different time windows. For example, a limit replenishment rate may be set to a lower value during time windows of lower historical minting activity (e.g., at night, on weekends, during holidays, or the like, when token minting activity is lower) and may be set to a higher value during time windows of higher historical minting activity (e.g., during daytime hours of weekdays, in which more and larger transactions are being performed on the blockchain).

Generally, the limit replenishment rate may increment the current token minting allowance by a specified amount of tokens after a defined amount of time has elapsed, up to the maximum token minting allowance defined for the rate-limited token minter 110. After the defined amount of time has elapsed, the current token minting allowance, which reflects the previous token minting allowance and the tokens that have been minted since the last time the token minting allowance was updated, may be compared to the maximum token minting allowance defined for the rate-limited token minter 110. If the difference between the maximum token minting allowance and the current token minting allowance is less than the limit replenishment rate, the mint limit manager 112 can set the current token minting allowance to the maximum token minting allowance instead of incrementing the token minting allowance by the limit replenishment rate so that the current token minting allowance does not exceed the maximum token minting allowance. If the current token minting allowance equals the maximum token minting allowance, the current token minting allowance may not be updated. If, however, the current token minting allowance is smaller than the maximum token minting allowance by at least the limit replenishment rate, the current token minting allowance may be incremented by the limit replenishment rate.

In some aspects, the maximum token minting allowance may be updated by an external party, such as an owner or controller of the token minter 120 or another trusted party. To update the maximum token minting allowance, a message including the new maximum token minting allowance may be cryptographically signed by the trusted party. The public keys associated with the trusted parties may be deployed to the rate-limited token minter 110 as part of an initial configuration of the rate-limited token minter 110 or in updates deployed to the rate-limited token minter. When a message with a mew maximum token minting allowance is received, the mint limit manager 112 can verify the signature associated with the message based on the public keys associated with the trusted parties that are allowed to update the maximum token minting allowance. If the signature is verified, the maximum token minting allowance may be updated to reflect the new maximum token minting allowance included in the message. In some aspects, the limit replenishment rate may similarly be updated by an external party. By allowing the maximum token minting allowance and/or limit replenishment rate to be updated by a trusted external party, a trusted external party can re-configure the limits to allow the rate-limited token minter 110 to handle burstiness in token minting activity while minimizing the amount of tokens that can be maliciously minted in a scenario in which the rate-limited token minter 110 is compromised by a malicious party.

In some aspects, updates to the maximum token minting allowance and/or the limit replenishment rate may be updated on a one-time basis or persistently based on parameters identified in the message received from a trusted party. For a one-time update to a token minting allowance, the mint limit manager 112 can configure the mint request handler 114 to deplete the amount specified in the one-time update to the token minting allowance before depleting the current token minting allowance. In some aspects, increases in the current token minting allowance may be paused until the one-time update to the token minting allowance is covered by the limit replenishment rate. For a one-time update to a limit replenishment rate, the amount specified in the one-time update instead of the a priori defined limit replenishment rate may be applied at the next time the current token minting allowance is updated.

The mint request handler 114 processes token mint requests received from a requesting party and determines whether to allow or block the minting of the requested tokens based on the current token minting allowance maintained by the mint limit manager 112. Generally, the mint request handler 114 compares the amount of tokens requested to be minted to the current token minting allowance and mints tokens based at least on the comparison of the amount of tokens requested to be minted to the current token minting allowance. When tokens are minted, the amount of tokens that are allowed to be minted (e.g., by requesting that the token minter 120 mint the requested amount of tokens, as illustrated in FIG. 1) are removed from the current token minting allowance.

When the amount of tokens requested to be minted exceeds the current token minting allowance, the mint request handler 114 can take various actions to determine whether to reject the request, partially satisfy the request, or mint the requested amount of tokens. In one example, the mint request handler 114 may be configured to reject any request to mint tokens when the amount of tokens requested to be minted exceeds the token minting allowance. In another example, the mint request handler 114 may be configured to partially satisfy the request and mint only an amount of tokens equal to the current token minting allowance.

In another example, the mint request handler 114 can be configured to attempt to satisfy the received token minting request by requesting an additional token minting allowance from a trusted party. For example, a reserve allowance maintained by a trusted party (e.g., the owner of the token minter 120) may be used to cover the delta between the requested number of tokens to be minted and the current token minting allowance. To use the reserve allowance, the rate-limited minter 110 can request, via a signed message, usage of the reserve allowance. If the reserve allowance allows for the minting of a sufficient number of tokens to satisfy the received token minting request, the mint request handler 114 can request that the token minter 120 mint the requested number of tokens using the entirety of the current token minting allowance for the rate-limited minter 110 and a portion of the reserve allowance. Generally, the reserve allowance may be a non-automatically-replenishing allowance that monotonically decreases as the reserve allowance is used. The reserve allowance may be reset manually when the reserve allowance is depleted, when the reserve allowance reaches a minimum amount threshold, or periodically.

In some aspects, the request to mint tokens may be generated by a trusted party and instructs the mint request handler to bypass token minting rate limits established for the rate-limited minter 110. In such a case, the request may be a signed message that allows the mint request handler 114 to determine that the request is from a trusted party. Based on verifying that the request is from a trusted party, the mint request handler 114 may instruct the token minter 120 to mint the requested amount of tokens and need not determine whether the current token minting allowance allows for the requested amount of tokens to be minted. By bypassing the token minting rate limits established for the rate-limited minter 110, minting of tokens via a signed request may also bypass the decrementing of the current token minting allowance.

The network 130 may, in some aspects, be a cryptocurrency network for which the rate-limited token minter 110 and the token minter 120 mints tokens for use in performing various transactions on the network. By way of example, network 130 may be a network such as ALGORAND™, BITCOIN™, ETHEREUM®, SOLANA™, STELLAR™, and other cryptocurrency networks. Transactions on a blockchain 132 hosted by network 130 may include, for example, the execution of one or more smart contracts on the blockchain 132 or by the generation of one or more blocks on the blockchain evidencing the occurrence of a transaction on the blockchain 132.

### Example Rate-Limited Minting of Tokens on a Blockchain

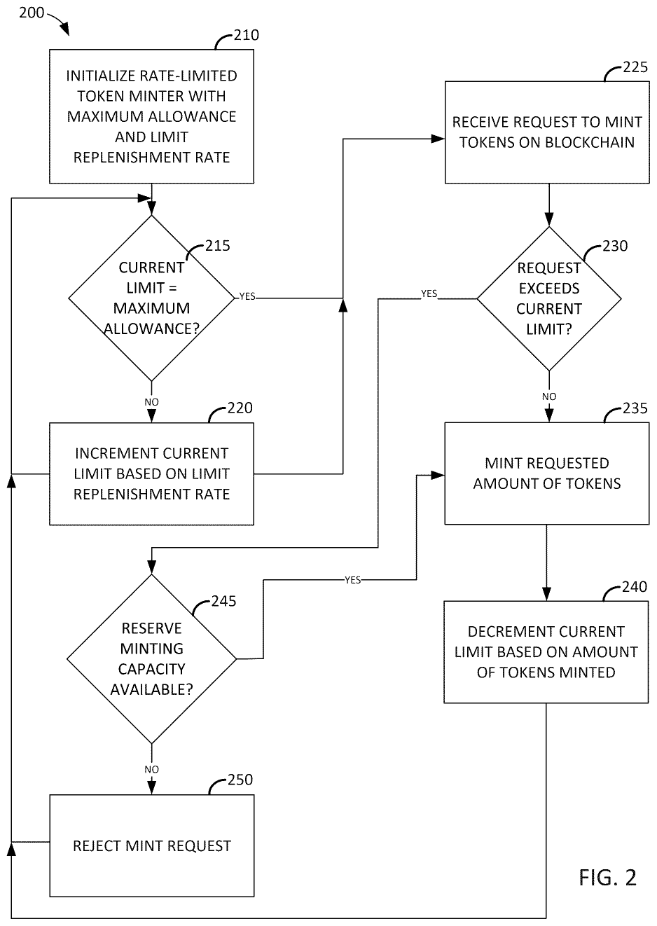

FIG. 2 is a flow chart illustrating operations 200 for rate-controlled minting of tokens on a blockchain, according to aspects of the present disclosure. The operations 200 may be performed, for example, by the rate-limited minter 110 illustrated in FIG. 1 or other computing devices on which a token minter can be deployed.

As illustrated, the operations 200 begin at block 210 with initializing the rate-limited token minter with a maximum allowance and a token minting allowance limit replenishment rate. In some aspects, the maximum allowance may be defined as a time-window-agnostic allowance that is replenished periodically based on the limit replenishment rate. In some aspects, the maximum allowance may be defined in terms of multiple time windows. A first time window may be a fixed time window that is updated periodically based on historical minting activity over a larger time window and a sliding time window that tracks token minting activity over a smaller time window terminating at the current time. Generally, the rate-limited token minter may be initialized with the maximum allowance and the limit replenishment rate by a trusted party, such as the owner of a token minter, a party that controls the issuance of tokens on the blockchain, or the like.

At block 215, the rate-limited token minter determines whether the current token minting allowance equals the maximum allowance with which the rate-limited token minter is configured. If the current token minting allowance equals the maximum allowance, the current token minting allowance should not be updated, and thus, operations 200 proceed to block 225 discussed in further detail below. If the current token minting allowance does not equal the maximum allowance, the current token minting allowance may grow by the limit replacement rate with which the rate-limited token minter is configured. Thus, operations 200 may proceed to block 220, where the current token minting allowance is incremented by the limit replacement rate. In some aspects, if the difference between the current token minting allowance and the maximum allowance is less than the limit replenishment rate, the current token minting allowance may be increased to the maximum allowance, or the rate increase may be bypassed until a next instance of executing block 215.

At block 225, the rate-limited token minter receives a request to mint tokens on the blockchain. The request generally specifies a number of tokens to be minted on the blockchain. In some aspects, as discussed above, the request may be signed, indicating that the rate limits enforced by the current token minting allowance and the limit replenishment rate may be bypassed. In such a case, though not illustrated, operations 200 may proceed directly to block 235 with minting the requested tokens.

At block 230, the rate-limited token minter determines whether the amount of tokens specified in the request to mint tokens on the blockchain exceeds the current token minting allowance with which the rate-limited token minter is configured.

If, at block 230, it is determined that the amount of tokens specified in the request is less than the current token minting allowance, the operations 200 may proceed to block 235 with minting the requested amount of tokens. In some aspects, to mint the requested amount of tokens, the rate-limited token minter may forward the request to mint the amount of tokens to a token minter that can directly mint tokens on the blockchain. In some aspects, the rate-limited token minter may be integrated with the token minter and may directly mint tokens to the blockchain.

Operations 200 may then proceed to block 240, where the rate-limited token minter decrements the current token minting allowance based on the amount of tokens minted by the rate-limited token minter. As discussed, in some aspects, where the request includes a signed request to bypass the rate limits enforced by the current token minting allowance, block 240 may be omitted. After updating the current token minting allowance based on the amount of tokens minted by the rate-limited token minter, the operations 200 may return to block 210 to update the current token minting allowance based on the limit replenishment rate.

If, at block 230, the rate-limited token minter determines that the amount of tokens specified in the request exceeds the current token minting allowance, operations 200 proceed to block 245, where it is determined whether reserve minting capacity is available for use by the rate-limited token minter. If, at block 245, it is determined that reserve minting capacity is available for use by the rate-limited token minter, operations 200 proceed to block 235 to mint the requested amount of tokens, as discussed above. When the minting of tokens involves the use of reserve minting capacity, the operations at block 240 may decrement both the current token allowance limit at the rate-limited token minter and the reserve minting capacity.

If, at block 245, it is determined that no reserve minting capacity is available for use by the rate-limited token minter, operations 200 may proceed to block 250. At block 250, the rate-limited token minter rejects the token mint request, and operations 200 return to block 210 to update the current token minting allowance based on the limited replenishment rate. In some aspects, in rejecting the token mint request, the rate-limited minter may queue the request to mint tokens for future execution (e.g., when the current token minting allowance equals or exceeds the amount of tokens specified in the request).

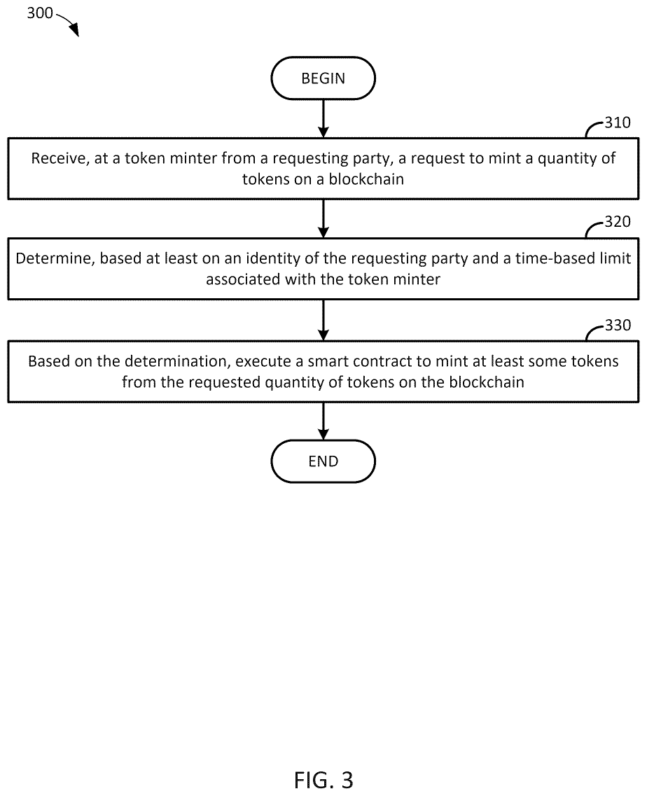

FIG. 3 illustrates example operations 300 for rate-controlled minting of tokens on a blockchain, according to aspects of the present disclosure. The operations 300 may be performed, for example, by the rate-limited minter 110 illustrated in FIG. 1 or other computing devices on which a token minter can be deployed.

As illustrated, the operations 300 begin at block 310, with receiving, at a token minter from a requesting party, a request to mint a quantity of tokens on a blockchain.

At block 320, the operations 300 proceed with determining, based at least on an identity of the requesting party and a time-based limit associated with the token minter, that the requested quantity of tokens are mintable by the token minter.

At block 330, the operations 300 proceed with executing a smart contract to mint at least some tokens from the requested quantity of tokens on the blockchain based on the determination of whether the requested quantity of tokens are mintable by the token minter.

In some aspects, the time-based limit comprises a limit configured to increase over time at a defined replenishment rate up to a maximum number of tokens. For example, the defined replenishment rate may allow for the time-based limit to increase periodically (e.g., every second, every minute, etc.) until a maximum size of the time-based limit (which may be configured a priori by a trusted party) is reached.

In some aspects, the operations 300 further include decrementing the time-based limit based on a number of tokens minted on the blockchain in response to executing the smart contract to mint the quantity of tokens on the blockchain.

In some aspects, the request comprises an indication that the time-based limit is to be increased by a defined amount to allow the request to be processed irrespective of a value of the time-based limit. The time-based limit generally resumes updating at a time based on the defined amount and the replenishment rate.

In some aspects, the time-based limit comprises a token minting limit over a current fixed time window and an average token minting rate over a sliding time window. In some aspects, determining that the requested quantity of tokens are mintable by the token minter includes determining that a total number of tokens minted over the current fixed time window is less than the token minting limit and determining that determining that an average token minting rate over the sliding time window is less than the average token minting rate over a time window prior to the sliding time window. In some aspects, the average toking minting rate over the sliding time window is based on an average minting rate over a prior fixed time window to the current fixed time window and an average minting rate over the current fixed time window.

In some aspects, the operations 300 further include determining that the quantity of tokens identified in the request exceeds the time-based limit. Based on determining that the quantity of tokens identified in the request exceeds the time-based limit, the request to mint the quantity of tokens on the blockchain may be rejected.

In some aspects, the operations 300 further include determining that the quantity of tokens identified in the request exceeds the time-based limit. Based on determining that the quantity of tokens identified in the request exceeds the time-based limit, the operations 300 proceed with determining whether a reserve allowance can be used to satisfy the request, wherein the reserve allowance comprises a token minting allowance maintained by a party separate from the token minter. Based on determining that the reserve allowance can be used to satisfy the request, the request to mint the quantity of tokens may be satisfied based on the time-based limit and a portion of the reserve allowance. For example, the time-based limit may be depleted, and the remaining amount of tokens may be minted from the reserve allowance. In some aspects, the reserve allowance comprises a token minting allowance periodically set by the party separate from the token minter.

In some aspects, the operations 300 further include dynamically adjusting the time-based limit associated with the token minter based on historical minting activity for the token minter for similar historical time windows.

In some aspects, the request may be a signed request indicating that the time-based limit is to be bypassed in minting the requested quantity of tokens. The signature associated with the signed request may be a cryptographic signature signed by a trusted party defined a priori.

### Example System for Rate-Limited Minting of Tokens on a Blockchain

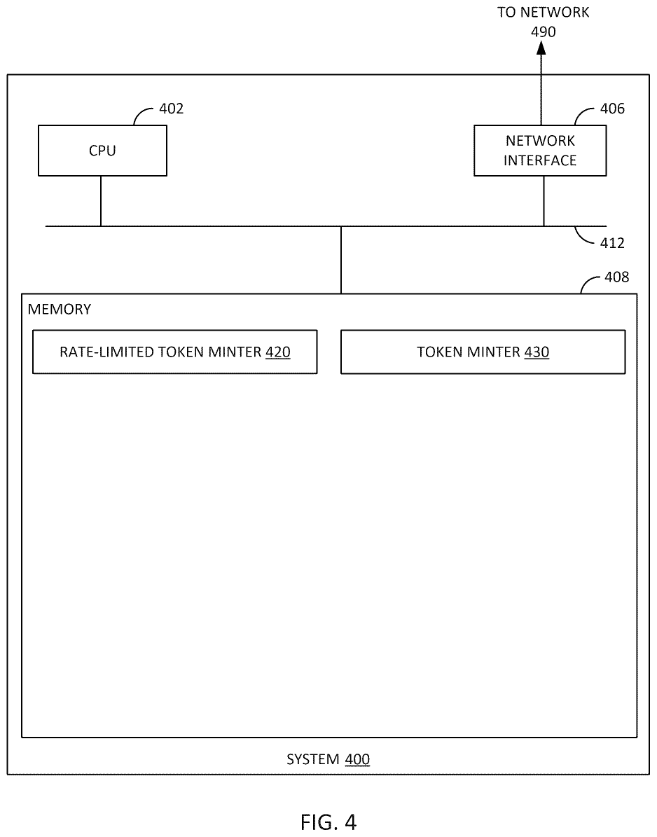

FIG. 4 illustrates an example system 400 configured to perform the methods described herein, including, for example, operations 200 illustrated in FIG. 2 and operations 300 illustrated in FIG. 3. In some aspects, system 400 may act as a computing system including one or more of a rate-limited minter 110 and/or a token minter 120 illustrated in FIG. 1.

As shown, system 400 includes a central processing unit (CPU) 402, network interface 406 through which system 400 is connected to network 490 (which may be a local network, an intranet, the internet, or any other group of computing devices communicatively connected to each other), a memory 408, and an interconnect 412. The network interface 406 may be used to receive requests to mint tokens on the blockchain (e.g., as depicted and described with respect to FIGS. 1 through 3).

CPU 402 may retrieve and execute programming instructions stored in the memory 408. Similarly, the CPU 402 may retrieve and store application data residing in the memory 408. The interconnect 412 transmits programming instructions and application data, among the CPU 402, network interface 406, and memory 408.

CPU 402 is included to be representative of a single CPU, multiple CPUs, a single CPU having multiple processing cores, and the like.

Memory 408 is representative of a volatile memory, such as a random access memory, or a nonvolatile memory, such as nonvolatile random access memory, phase change random access memory, or the like. As shown, memory 408 includes a rate-limited token minter 420 and a token minter 430.

The rate-limited token minter 420 generally corresponds to the rate-limited token minter 110 illustrated in FIG. 1. The rate-limited token minter 420 may serve as an entry point for requests to mint tokens on the blockchain. To manage the minting of tokens on the blockchain, the rate-limited token minter 420 may be configured with a token minting limit. In some aspects, the token minting limit may be a replenishable limit that increases over time by a defined replenishment rate. In some aspects, the token minting limit may be a time-window-based limit that accounts for historical token minting activity over similar epochs (e.g., a weekday business hour limit, a weekday non-business-hour limit, a weekend limit, a holiday limit, etc.) and for average token minting activity over a sliding time window. When the rate-limited token minter 420 receives a request to mint tokens on the blockchain, the rate-limited token minter 420 can determine whether the token minting limit allows for the minting of the requested number of tokens on the blockchain. If the token minting limit allows for the minting of the requested number of tokens on the blockchain, the rate-limited token minter 420 can invoke a smart contract provided by the token minter 430 (which corresponds to the token minter 120 illustrated in FIG. 1) to mint the requested number of tokens. If, however, the token minting limit does not allow for the minting of the requested number of tokens on the blockchain, the rate-limited token minter 420 can attempt to use a reserve allowance to satisfy the request or may reject the request.

In some aspects, the rate-limited token minter 420 may be instructed to bypass the token minting limit. Generally, a request to mint tokens that bypasses the token minting limit may be a cryptographically signed message from a trusted party. A request to mint tokens that bypasses the token minting limit may, in some aspects, include a one-time increase in the token minting limit that allows for the requested number of tokens to be minted irrespective of the token minting limit. In some aspects, updates to the token minting limit may be delayed based on the amount of the one-time increase and a limit replenishment rate with which the rate-limited token minter is configured. In some aspects, a request to mint tokens that bypasses the token minting limit may include a message explicitly instructing the rate-limited token minter 420 to bypass determining whether the token minting limit is sufficiently sized to allow for the minting of the requested number of tokens.

### Example Clauses

Implementation details for various aspects of the present disclosure are described in the following numbered clauses.

Clause 1: A processor-implemented method for managing token minting in blockchain systems, comprising: receiving, at a token minter from a requesting party, a request to mint a quantity of tokens on a blockchain; determining, based at least on an identity of the requesting party and a time-based limit associated with the token minter, that the requested quantity of tokens are mintable by the token minter; and based on the determination, executing a smart contract to mint at least some tokens from the requested quantity of tokens on the blockchain.

Clause 2: The method of Clause 1, wherein the time-based limit comprises a limit configured to increase over time at a defined replenishment rate up to a maximum number of tokens.

Clause 3: The method of Clause 2, wherein the request comprises an indication that the time-based limit is to be increased by a defined amount to allow the request to be processed irrespective of a value of the time-based limit, and wherein the time-based limit resumes updating at a time based on the defined amount and the replenishment rate.

Clause 4: The method of any of Clauses 1 through 3, further comprising decrementing the time-based limit based on a number of tokens minted on the blockchain in response to executing the smart contract to mint the quantity of tokens on the blockchain.

Clause 5: The method of any of Clauses 1 through 4, further comprising: determining that the quantity of tokens identified in the request exceeds the time-based limit; and rejecting the request based on the determining that the quantity of tokens identified in the request exceeds the time-based limit.

Clause 6: The method of any of Clauses 1 through 5, wherein the time-based limit comprises a token minting limit over a current fixed time window and an average token minting rate over a sliding time window.

Clause 7: The method of Clause 6, wherein determining that the requested quantity of tokens are mintable by the token minter comprises: determining that a total number of tokens minted over the current fixed time window is less than the token minting limit, and determining that an average token minting rate over the sliding time window is less than the average token minting rate over a time window prior to the sliding time window.

Clause 8: The method of any of Clauses 6 or 7, wherein the average toking minting rate over the sliding time window is based on an average minting rate over a prior fixed time window to the current fixed time window and an average minting rate over the current fixed time window.

Clause 9: The method of any of Clauses 1 through 8, further comprising: determining that the quantity of tokens identified in the request exceeds the time-based limit; and based on determining that the quantity of tokens identified in the request exceeds the time-based limit, determining whether a reserve allowance can be used to satisfy the request, wherein the reserve allowance comprises a token minting allowance maintained by a party separate from the token minter; and based on determining that the reserve allowance can be used to satisfy the request, satisfying the request to mint the quantity of tokens based on the time-based limit and a portion of the reserve allowance.

Clause 10: The method of Clause 9, wherein the reserve allowance comprises a token minting allowance periodically set by the party separate from the token minter.

Clause 11: The method of any of Clauses 1 through 10, further comprising dynamically adjusting the time-based limit associated with the token minter based on historical minting activity for the token minter for similar historical time windows.

Clause 12: The method of any of Clauses 1 through 11, wherein the request comprises a signed request indicating that the time-based limit is to be bypassed in minting the requested quantity of tokens.

Clause 13: A system, comprising: a memory having executable instructions stored thereon; and a processor configured to execute the executable instructions to perform the operations of any one of Clauses 1 through 12.

Clause 14: A system, comprising: means for performing the operations of any one of Clauses 1 through 12.

Clause 15: A computer-readable medium having instructions stored thereon which, when executed by a processor, performs the operations of any one of Clauses 1 through 12.

### ADDITIONAL CONSIDERATIONS

The preceding description is provided to enable any person skilled in the art to practice the various aspects described herein. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for managing token minting in blockchain systems, comprising:
receiving, at a token minter from a requesting party, a request to mint a quantity of tokens on a blockchain;
determining, based at least on an identity of the requesting party and a time-based limit associated with the token minter, that the requested quantity of tokens are mintable by the token minter; and
based on the determination, executing a smart contract to mint at least some tokens from the requested quantity of tokens on the blockchain.

2. The method of claim 1, wherein the time-based limit comprises a limit configured to increase over time at a defined replenishment rate up to a maximum number of tokens.

3. The method of claim 2, wherein the request comprises an indication that the time-based limit is to be increased by a defined amount to allow the request to be processed irrespective of a value of the time-based limit, and wherein the time-based limit resumes updating at a time based on the defined amount and the replenishment rate.

4. The method of claim 1, further comprising decrementing the time-based limit based on a number of tokens minted on the blockchain in response to executing the smart contract to mint the quantity of tokens on the blockchain.

5. The method of claim 1, further comprising:
determining that the quantity of tokens identified in the request exceeds the time-based limit; and
rejecting the request based on the determining that the quantity of tokens identified in the request exceeds the time-based limit.

6. The method of claim 1, wherein the time-based limit comprises a token minting limit over a current fixed time window and an average token minting rate over a sliding time window.

7. The method of claim 6, wherein determining that the requested quantity of tokens are mintable by the token minter comprises:
determining that a total number of tokens minted over the current fixed time window is less than the token minting limit, and
determining that an average token minting rate over the sliding time window is less than the average token minting rate over a time window prior to the sliding time window.

8. The method of claim 6, wherein the average toking minting rate over the sliding time window is based on an average minting rate over a prior fixed time window to the current fixed time window and an average minting rate over the current fixed time window.

9. The method of claim 1, further comprising:
determining that the quantity of tokens identified in the request exceeds the time-based limit;
based on determining that the quantity of tokens identified in the request exceeds the time-based limit, determining whether a reserve allowance can be used to satisfy the request, wherein the reserve allowance comprises a token minting allowance maintained by a party separate from the token minter; and
based on determining that the reserve allowance can be used to satisfy the request, satisfying the request to mint the quantity of tokens based on the time-based limit and a portion of the reserve allowance.

10. The method of claim 9, wherein the reserve allowance comprises a token minting allowance periodically set by the party separate from the token minter.

11. The method of claim 1, further comprising dynamically adjusting the time-based limit associated with the token minter based on historical minting activity for the token minter for similar historical time windows.

12. The method of claim 1, wherein the request comprises a signed request indicating that the time-based limit is to be bypassed in minting the requested quantity of tokens.

13. A processing system, comprising:
at least one memory having executable instructions stored thereon; and
one or more processors configured to execute the executable instructions to cause the processor to:
receive, at a token minter from a requesting party, a request to mint a quantity of tokens on a blockchain;
determine, based at least on an identity of the requesting party and a time-based limit associated with the token minter, that the requested quantity of tokens are mintable by the token minter; and
based on the determination, execute a smart contract to mint at least some tokens from the requested quantity of tokens on the blockchain.

14. The processing system of claim 13, wherein the time-based limit comprises a limit configured to increase over time at a defined replenishment rate up to a maximum number of tokens.

15. The processing system of claim 14, wherein the request comprises an indication that the time-based limit is to be increased by a defined amount to allow the request to be processed irrespective of a value of the time-based limit, and wherein the time-based limit resumes updating at a time based on the defined amount and the replenishment rate.

16. The processing system of claim 13, wherein the one or more processors are further configured to cause the processing system to decrement the time-based limit based on a number of tokens minted on the blockchain in response to executing the smart contract to mint the quantity of tokens on the blockchain.

17. The processing system of claim 13, wherein the one or more processors are further configured to cause the processing system to:
determine that the quantity of tokens identified in the request exceeds the time-based limit; and
reject the request based on the determining that the quantity of tokens identified in the request exceeds the time-based limit.

18. The processing system of claim 13, wherein the time-based limit comprises a token minting limit over a current fixed time window and an average token minting rate over a sliding time window.

19. The processing system of claim 18, wherein to determine that the requested quantity of tokens are mintable by the token minter, the one or more processors are configured to cause the processing system to:
determine that a total number of tokens minted over the current fixed time window is less than the token minting limit, and
determine that an average token minting rate over the sliding time window is less than the average token minting rate over a time window prior to the sliding time window.

20. The processing system of claim 18, wherein the average toking minting rate over the sliding time window is based on an average minting rate over a prior fixed time window to the current fixed time window and an average minting rate over the current fixed time window.

21. The processing system of claim 13, wherein the one or more processors are further configured to cause the processing system to:
determine that the quantity of tokens identified in the request exceeds the time-based limit;
based on determining that the quantity of tokens identified in the request exceeds the time-based limit, determine whether a reserve allowance can be used to satisfy the request, wherein the reserve allowance comprises a token minting allowance maintained by a party separate from the token minter; and
based on determining that the reserve allowance can be used to satisfy the request, satisfy the request to mint the quantity of tokens based on the time-based limit and a portion of the reserve allowance.

22. The processing system of claim 21, wherein the reserve allowance comprises a token minting allowance periodically set by the party separate from the token minter.

23. The processing system of claim 13, wherein the one or more processors are further configured to cause the processing system to dynamically adjust the time-based limit associated with the token minter based on historical minting activity for the token minter for similar historical time windows.

24. The processing system of claim 13, wherein the request comprises a signed request indicating that the time-based limit is to be bypassed in minting the requested quantity of tokens.

25. A non-transitory computer-readable medium having executable instructions stored thereon which, when executed by one or more processors, performs an operation for managing token minting in blockchain systems, the operation comprising:
receiving, at a token minter from a requesting party, a request to mint a quantity of tokens on a blockchain;
determining, based at least on an identity of the requesting party and a time-based limit associated with the token minter, that the requested quantity of tokens are mintable by the token minter; and
based on the determination, executing a smart contract to mint at least some tokens from the requested quantity of tokens on the blockchain.
